(19) United States
(12) Patent Application Publication
(10) Pub. No.: US 2018/0272894 A1
(43) Pub. Date: Sep. 27, 2018

(54) VEHICLE OCCUPANCY ALERT SYSTEM AND METHOD

(71) Applicant: Alan Logan, Philadelphia, PA (US)

(72) Inventor: Alan Logan, Philadelphia, PA (US)

(21) Appl. No.: 15/666,454

(22) Filed: Aug. 1, 2017

Related U.S. Application Data
(60) Provisional application No. 62/477,400, filed on Mar. 27, 2017.

(51) Int. Cl. B60N 2/00; G08B 21/02

(52) U.S. Cl. CPC B60N 2/002; B60Y 2400/90; B60Y 2400/92; G08B 21/02

(57) ABSTRACT

A passenger seat occupancy alert system for a vehicle is disclosed herein. The passenger seat occupancy alert system for a vehicle includes at least one sensor, a detection means, an in-vehicle display device, a speaker, and a controller. The passenger seat occupancy alert system is useful for sensing passenger occupancy of a vehicle and producing an alert.

### CROSS REFERENCE TO RELATED APPLICATION

The present application is related to and claims priority to U.S. Provisional Patent Application No. 62/477,400 filed Mar. 27, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of vehicle alert systems and more specifically relates to a system for sensing passenger occupancy of a vehicle.

### 2. Description of Related Art

When transporting children, instances have been noted where children and pets have been left in a vehicle for prolonged periods. This may happen especially for sleeping infants who make no noise. If a child or pet is left behind in a hot/cold, locked vehicle, the child or pet could suffer from serious injuries and even death. Furthermore other sensitive and/or valuable items may be left behind in a vehicle. People who store groceries in the back seat may purchase perishable items and then get distracted, leaving the items behind in a vehicle. In addition, a person may leave their valuables such as laptop, tablet, etc. in clear view in the vehicle which puts the vehicle at risk of being broken into and the valuables stolen. Thus, a suitable solution is desired.

U.S. Pat. No. 6,489,889 to Craig Smith relates to an occupant sensing system. The described occupant sensing system includes seat belt sensor for detecting a buckled condition of the seat belt. an ignition sensor generates an ignition-off signal. an indicator is coupled to a controller, the seat belt sensor, and the ignition sensor. the controller controls the indicator in response to the seat belt buckled signal and ignition-off signal.

### BRIEF SUMMARY OF THE INVENTION

In view of the foregoing disadvantages inherent in the known vehicle alert systems art, the present disclosure provides a novel vehicle occupancy alert system and method. The general purpose of the present disclosure, which will be described subsequently in greater detail, is to provide a vehicle alert system to alert a user when a passenger seat occupant is detected.

A passenger seat occupancy alert system for a vehicle is disclosed herein. The passenger seat occupancy alert system for a vehicle includes at least one sensor coupled to the at least one passenger seat, the at least one sensor configured to detect when the at least one passenger seat may be occupied by an object, the at least one sensor further configured to transmit a sensor signal when the at least one passenger seat may be occupied by the object, a detection means configured to detect an off-state of the ignition system, the detection means further configured to transmit a vehicle signal when the ignition system may be in the off-state, an in-vehicle display device communicably coupled with the at least one sensor and with the detection means, the in-vehicle display device configured to display an alert; a speaker configured to sound an alarm; and a controller configured to sound the alarm and to display the alert on the in-vehicle display device.

A method for installing a passenger seat occupancy alert system for a vehicle is also disclosed herein. The method for installing the passenger seat occupancy alert system for a vehicle includes the steps of: coupling at least one sensor to the at least one passenger seat (the at least one sensor configured to detect when the at least one passenger seat may be occupied by an object); installing a detection means proximate the ignition key switch (the detection means configured to detect an off-state off the ignition key switch, and to transmit a signal when the ignition key switch may be in the off-state), installing an in-vehicle display device to the dashboard of the vehicle (the in-vehicle display device configured to display an alert; positioning the in-vehicle display device on the dashboard such that the alert displayed by the in-vehicle display device may be viewable by a driver of the vehicle); and communicably coupling the in-vehicle display device with the at least one sensor and the detection means.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle occupancy alert system and method, constructed and operative according to the teachings of the present disclosure.

FIG. 1 is a perspective view of a passenger seat occupancy alert system for a vehicle during an ‘in-use’ condition, according to an embodiment of the disclosure.

FIG. 2 is a perspective view of the passenger seat occupancy alert system for a vehicle showing sensors in the passenger seats according to an embodiment of the present disclosure.

FIG. 3 is a detail view of portions of the passenger seat occupancy alert system for a vehicle showing an in-vehicle display device according to an embodiment of the present disclosure.

FIG. 4A is a perspective view of aspects of a passenger seat occupancy alert system for a vehicle showing a detection means according to an embodiment of the present disclosure.

FIG. 4B is a perspective view of aspects of the passenger seat occupancy alert system, according to an embodiment of the present disclosure.

FIG. 5 is a flow diagram illustrating a method of use for passenger seat occupancy alert system for a vehicle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle alert systems and more particularly to a vehicle occupancy alert system and method as used to improve the systems for sensing passenger occupancy of a vehicle and producing an alert.

Generally disclosed is a system for detecting the occupancy of a motor vehicle to reduce the probability of a person being left in a passenger seat of a vehicle. The system may include a sensing component to detect the occupancy of passenger seats in a vehicle. The system may further comprise an indicator to alert the vehicle operator when the ignition is disengaged in the form of a visual or audible indicator or alarm. The present disclosure may provide vehicles with a dashboard display capable of emitting audio and flashing lights when detecting children, pets, and others in the back seat when a vehicle is turned off. It may utilize weight sensors to determine when people or items are left in the back seat. A loud alarm may sound and flashing LED lights may alert on the dashboard display if a vehicle ignition is turned off and the weight sensors detect a presence in the rear seat. This may eliminate the worry of leaving a child or pet behind in an extremely hot or cold vehicle. The system may install conveniently in any type of vehicle including cars, trucks, SUVs, and more during manufacture or after manufacture.

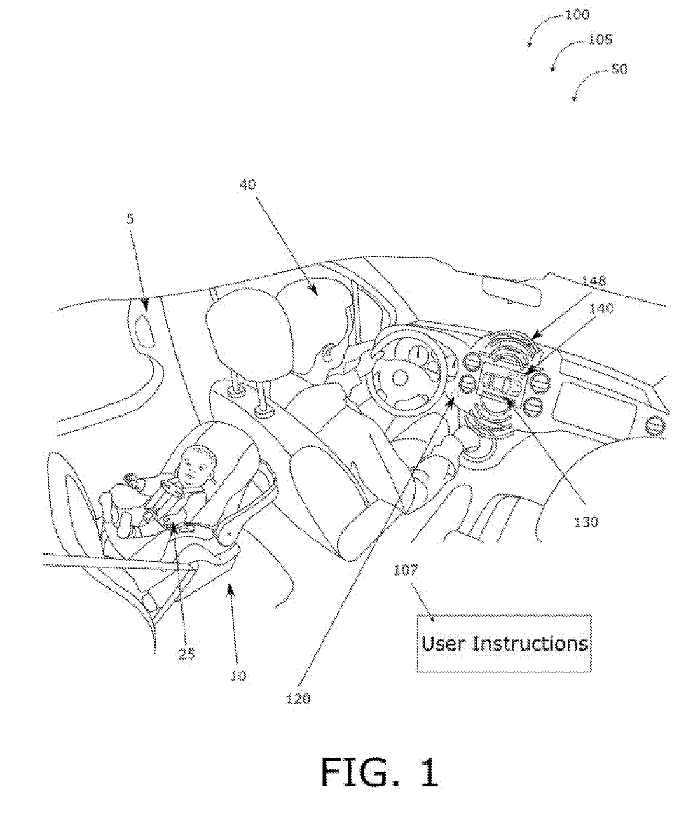

Referring now more specifically to the drawings by numerals of reference, there is shown in FIGS. 1-5, various views of a passenger seat occupancy alert system for a vehicle 100.

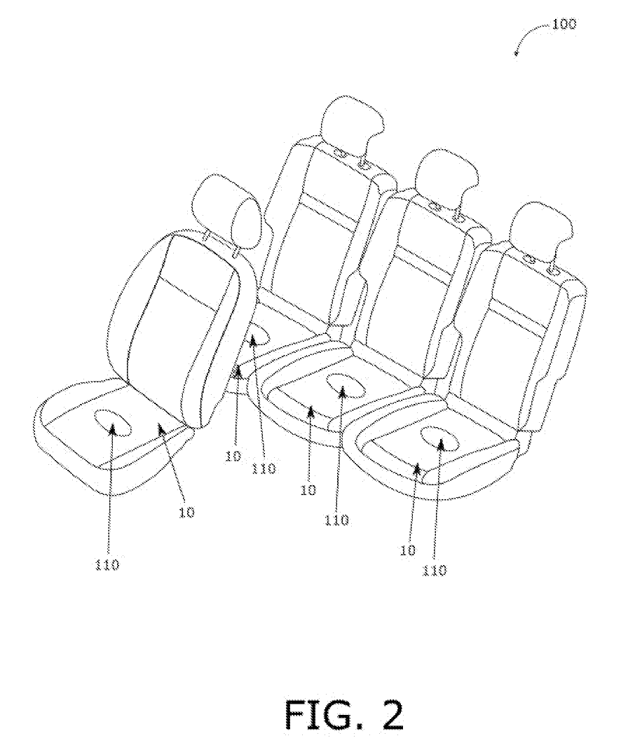

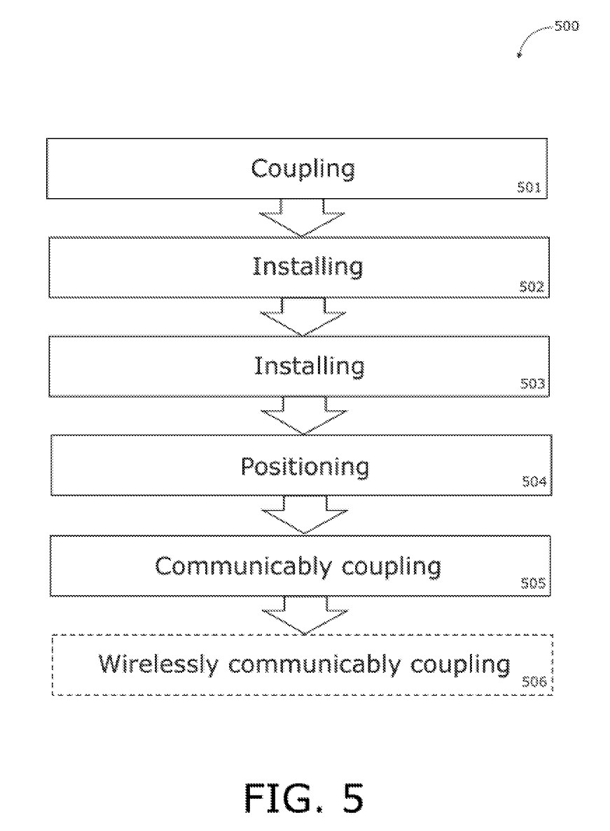

FIG. 1 is a perspective view of a passenger seat occupancy alert system for a vehicle 100 during an ‘in-use’ condition 50, according to an embodiment of the present disclosure. As illustrated, the passenger seat occupancy alert system for a vehicle 100 may include at least one sensor 110 (FIG. 2), a means for detecting an off-state of an ignition system of the vehicle 5 and transmitting a vehicle signal when the ignition system is in the off-state (“detection means 120”), an in-vehicle display device 130, a speaker 140, and a controller 150 (FIG. 5). Together, these elements of the passenger seat occupancy alert system for a vehicle 100 may provide an alert a user 40 when at least one passenger seat 10 of a vehicle 5 is occupied by an object 25 (e.g., child, pet, etc.).

According to one embodiment, the passenger seat occupancy alert system for a vehicle 100 may be arranged as a kit 105. The kit 105 may include a set of instructions 107. The instructions 107 may detail functional relationships in relation to the structure of the passenger seat occupancy alert system for a vehicle 100 (such that the passenger seat occupancy alert system for a vehicle 100 can be used, maintained, or the like, in a preferred manner).

FIG. 2 is a perspective view of the passenger seat occupancy alert system for a vehicle of FIG. 1, showing sensors in the passenger seats, according to an embodiment of the present disclosure. Illustrated here are the at least one sensor 110 coupled to the at least one passenger seat 10. In this embodiment, the at least one sensor 110 may be coupled to the at least one passenger seat 10, the at least one sensor 110 configured to detect when the at least one passenger seat 10 is occupied by an object 25 (FIG. 1), the at least one sensor 110 further configured to transmit a sensor signal when the at least one passenger seat 10 is occupied by the object 25.

In a preferred embodiment, the at least one sensor 110 may include a weight sensor. Further, the at least one sensor 110 may configured to detect the object 25 having a weight of at least 2 lb. In a preferred embodiment, the at least one sensor 110 may be integrated within the at least one passenger seat 10. In one example, the weight sensor may include at least one load cell coupled to at least one load path. In this example, the load cells may use a strain gage, a force sensitive resistive element, or the like. In other examples, the weight sensor may include a hydrostatic weight sensing element in communication with a pressure sensor. This pressure sensor may be in electronic communication with the controller 150.

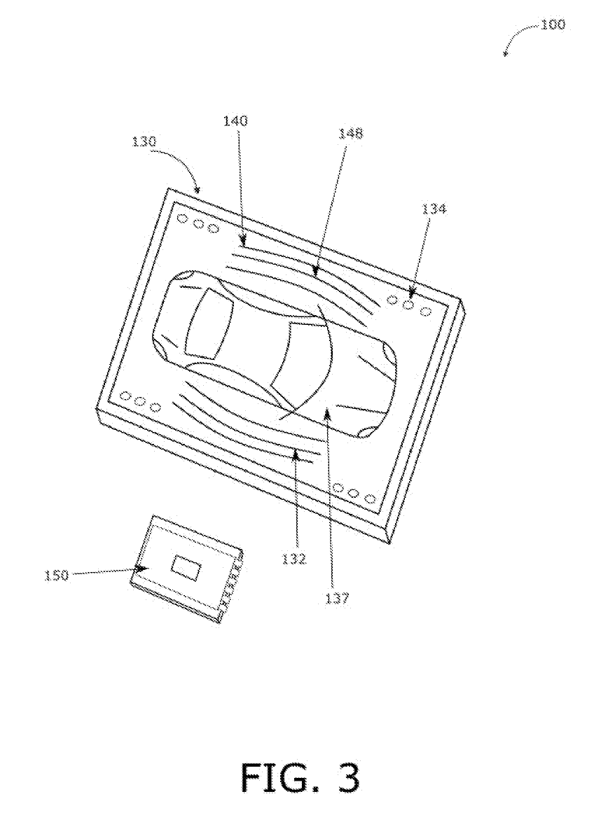

FIG. 3 is a detail view of portions of the passenger seat occupancy alert system for a vehicle of FIG. 1, showing an in-vehicle display device, according to an embodiment of the present disclosure. Illustrated in this figure is the in-vehicle display device 130, the speaker 140, and the controller 150. As shown, the in-vehicle display device 130 and the speaker 140 may be integrated together as a single unit. Likewise, the controller 150 may be integrated with the in-vehicle display device 130 and/or the speaker 140.

In one embodiment, the controller 150 may be or include a single integrated circuit (IC) chip located within the in-vehicle display device 130. A central processing unit (CPU) located on the IC chip may carry out an instruction set to perform basic arithmetic, logical, control and input/output (I/O) operations specified by an instruction set. Alternately, the controller 150 may be a standalone device communicably coupled to a communication bus (e.g., vehicle CAN bus), or may be at least partially integrated into a vehicle controller.

The in-vehicle display device 130 may be communicably coupled with the at least one sensor 110 and with the detection means 120, and may be further configured to display an alert 137 (e.g., flashing image of the vehicle). Further, the speaker 140 may be configured to sound an alarm 148, and the controller 150 may be configured to sound the alarm 148 and to display the alert 137 on the in-vehicle display device 130.

According to one embodiment, the in-vehicle display device 130 may be configured to display the alert 137 after a predetermined time interval upon receipt of the sensor signal from the at least one sensor 110 (FIG. 2) that the at least one passenger seat 10 (FIG. 1) is occupied by the object 25 (FIG. 1), and of the vehicle signal from the detection means 120 (FIG. 1) that the ignition system of the vehicle 5 (FIG. 1) is in the off-state.

As above, the speaker 140 and the controller 150 may be embedded into, or otherwise integrated with, the in-vehicle display device 130. In the preferred embodiment, the in-vehicle display device 130 may include a wireless transceiver, and the at least one sensor 110 and the detection means 120 may be configured to wirelessly communicate with the in-vehicle display device 130. According to one embodiment, the wireless transceiver may be a radio frequency module (RF module) which may be embedded in the controller 150. In this embodiment, the at least one sensor 110 and the detection means 120 may wirelessly communicate with the RF module via radio frequency communication (RF communication). Further wireless communication examples may include WiFi, Bluetooth, or the like.

In the preferred embodiment, the in-vehicle display device 130 may include a liquid crystal display (LCD) screen 132. Further to this, the in-vehicle display device 130 may include a plurality of light-emitting diodes (LEDs) 134. In this embodiment, the alert 137 may include the plurality of light-emitting diodes 134 flashing at a predetermined rate. The in-vehicle display device 130 may be configured to install on a dashboard of the vehicle 5 and situated such that the in-vehicle display device 130 may be in view of the user 40 (FIG. 1), for example a driver of the vehicle 5. In other embodiments, the in-vehicle display device 130 may be configured to install into other areas of the vehicle 5, such as a center console.

The controller 150 may be configured to activate the in-vehicle display device 130 upon receipt of the sensor signal from the at least one sensor 110 that the at least one passenger seat 10 is occupied by the object 25. Further, the controller 150 may be configured to display the alert 137 in real-time, responsive to and upon receipt of the sensor signal from the at least one sensor 110 that the at least one passenger seat 10 is occupied by the object 25 and the vehicle signal from the detection means 120 that the ignition system is in the off-state. Similarly, the controller 150 may be further configured to sound the alarm 148 through the speaker 140 in real-time, responsive to and upon the receipt of the sensor signal from the at least one sensor 110 that the at least one passenger seat 10 is occupied by the object 25 and the vehicle signal from the detection means 120 that the ignition system is in the off-state.

The controller 150 may be configured to activate the in-vehicle display device 130 upon receipt of the sensor signal from the at least one sensor 110 that the at least one passenger seat 10 is occupied by the object 25. Further, the controller 150 may be configured to display the alert 137 in real-time, responsive to and upon receipt of the sensor signal from the at least one sensor 110 that the at least one passenger seat 10 is occupied by the object 25 and the vehicle signal from the detection means 120 that the ignition system is in the off-state. Similarly, the controller 150 may be further configured to sound the alarm 148 through the speaker 140 in real-time, responsive to and upon the receipt of the sensor signal from the at least one sensor 110 that the at least one passenger seat 10 is occupied by the object 25 and the vehicle signal from the detection means 120 that the ignition system is in the off-state.

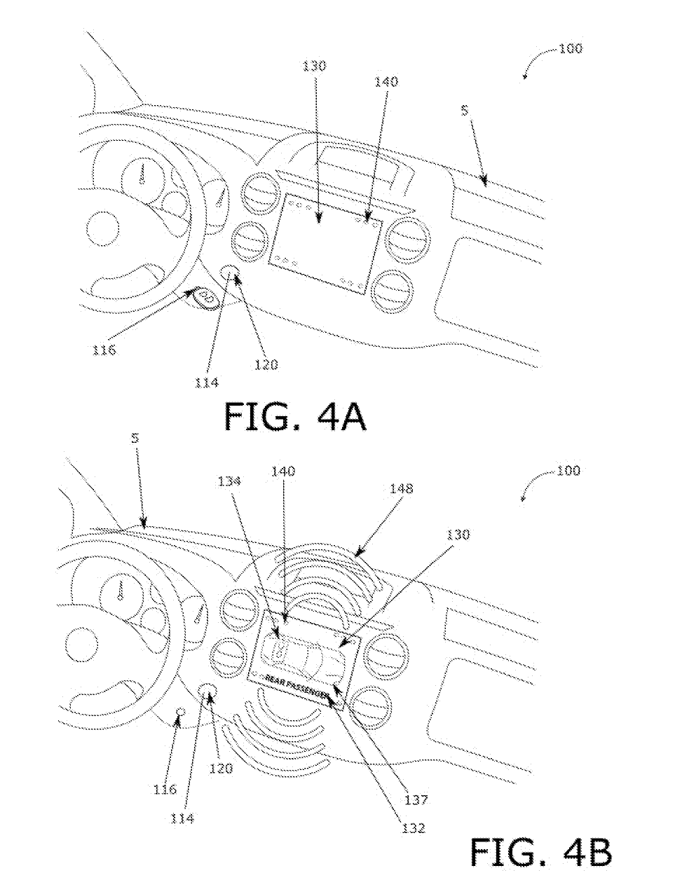

FIG. 4A is a front perspective view of aspects of the passenger seat occupancy alert system for a vehicle, showing a means for detecting an off-state of an ignition system of the vehicle (detection means 120), according to an embodiment of the present disclosure. In addition to detecting the off-state of an ignition system of the vehicle 5, the detection means 120 may transmit a vehicle signal when the ignition system is in the off-state to the controller 150 (FIG. 3). The detection means 120 may utilize several techniques for detection of the ignition system being in the off-state. For example, the detection means 120 may directly determine the position/presence of a vehicle key, the presence of the drive, the state of engine operation via an ECU or other vehicle signaling, etc.

Here, a key is shown in a key ignition switch 116 of the vehicle 5 to illustrate an on-state of the ignition system. Accordingly, the detection means 120 may be configured to detect the off-state of the ignition system relative to the state of the key ignition switch 116 and be configured to transmit a vehicle signal when the ignition system is in the off-state. In a preferred embodiment, the detection means 120 may include a key position sensor 114 located proximate the key ignition switch 116 in the vehicle 5, and configured to transmit the vehicle signal to the controller 150 when the key ignition switch 116 is in the off-state. It should be noted that the key position sensor 114 is conveniently illustrated as being located apart from the key ignition switch 116, however, embodiments may include the key position sensor 114 being substantially collocated with the key ignition switch 116. In this embodiment, the key position sensor 114 may include a proximity sensor. The proximity sensor may emit an electromagnetic field and look for changes in the field. In this instance, upon a position change of a key in the key ignition switch 116 to an off-state, the proximity sensor may sense the change in the electromagnetic field and send the vehicle signal to the controller 150 to activate the alarm 148 and the alert 137. The position change of the key in the key ignition switch 116 may include removal of the key, or rotation of the key in the key ignition switch 116 to an off-state. Further examples of the key position sensor 114 may include a capacitive displacement sensor, a hall-effect sensor adjacent a magnet, or the like.

In another embodiment, the detection means 120 may include an ignition sensor communicably coupled to the ignition system of the vehicle, and configured to transmit the vehicle signal to the controller 150 when the ignition system is in the off-state. In this embodiment, the detection means 120 may receive episodic sonic pulses from the ignition system of the vehicle to provide an indication that the vehicle ignition is in an on-state. In this instance, when the episodic sonic pulses stop, the detection means 120 may send the vehicle signal to the controller 150 to activate the alarm 148 and the alert 137.

FIG. 4B is a perspective view of aspects of the passenger seat occupancy alert system, according to an embodiment of the present disclosure. Here, the key is removed from the key ignition switch 116, and as such the detection means 120 has transmitted the vehicle signal to the controller 150 which has activated the in-vehicle display device 130 to sound the alarm 148 and display the alert 137.

As above, the detection means 120 may include the key position sensor 114 located proximate the key ignition switch 116 in the vehicle 5, and configured to transmit the vehicle signal to the controller 150 when the key ignition switch 116 is in the off-state. The controller 150 may be configured to display the alert 137 in real-time, responsive to and upon receipt of the sensor signal from the at least one sensor 110 (FIG. 2) that the at least one passenger seat 10 (FIG. 2) is still occupied by the object 25 (FIG. 1) and the vehicle signal from the detection means 120 that the ignition system is in the off-state.

According to one embodiment, the controller 150 may be configured to sound the alarm 148 through the speaker 140 in real-time, responsive to and upon the receipt of the sensor signal from the at least one sensor 110 that the at least one passenger seat 10 is occupied by the object 25 and the vehicle signal from the detection means 120 that the ignition system is in the off-state. This may be advantageous as, the driver may be notified before ever exiting the vehicle 5.

According to another embodiment, the in-vehicle display device 130 may be configured to display the alert 137 after a predetermined time interval upon receipt of the sensor signal from the at least one sensor 110 that the at least one passenger seat 10 is occupied by the object 25, and of the vehicle signal from the detection means 120 that the ignition system is in the off-state. Further, the in-vehicle display device 130 may be configured to sound the alarm 148 through the speaker 140 after a predetermined time interval upon receipt of the sensor signal from the at least one sensor 110 that the at least one passenger seat 10 is occupied by the object 25, and of the vehicle signal from the detection means 120 that the ignition system is in the off-state. The predetermined time interval may ensure time is provided to allow the object 25 to be removed from the vehicle 5. The predetermined time interval may be at least one minute.

FIG. 5 is a flow diagram illustrating a method for installing a passenger seat occupancy alert system to a vehicle (“method 500”), according to an embodiment of the present disclosure. In particular, the method 500 may include one or more components or features of the passenger seat occupancy alert system for a vehicle 100 as described above and illustrated in FIGS. 1-4B. As illustrated, the method 500 may include the steps of: step one 501, coupling at least one sensor 110 to the at least one passenger seat 10, the at least one sensor 110 configured to detect when the at least one passenger seat 10 is occupied by an object 25; step two 502, installing a detection means 120 proximate the ignition key switch 116, the detection means 120 configured to detect an off-state off the ignition key switch 116, and to transmit a signal when the ignition key switch 116 is in the off-state; step three 503, installing an in-vehicle display device 130 to the dashboard of the vehicle, the in-vehicle display device 130 configured to display an alert 137; step four 504, positioning the in-vehicle display device 130 on the dashboard such that the alert 137 displayed by the in-vehicle display device 130 is viewable by a driver of the vehicle; and step five 505, communicably coupling the in-vehicle display device 130 with the at least one sensor 110 and the detection means 120. According to one embodiment, the method 500 may further include a step six 506, wirelessly communicably coupling the in-vehicle display device 130 with the at least one sensor 110 and the detection means 120.

It should be noted that step six 506 is an optional step and might not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for passenger seat occupancy alert system for a vehicle 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A passenger seat occupancy alert system for a vehicle, the vehicle including at least one passenger seat and an ignition system, the passenger seat occupancy alert system comprising:
at least one sensor coupled to the at least one passenger seat, the at least one sensor configured to detect when the at least one passenger seat is occupied by an object, the at least one sensor further configured to transmit a sensor signal when the at least one passenger seat is occupied by the object;
a detection means configured to detect an off-state of the ignition system, the detection means further configured to transmit a vehicle signal when the ignition system is in the off-state;
an in-vehicle display device communicably coupled with the at least one sensor and with the detection means, the in-vehicle display device configured to display an alert;
a speaker configured to sound an alarm;
a controller configured to sound the alarm and to display the alert on the in-vehicle display device;
an ignition sensor configured to receive episodic sonic pulses from the ignition system of the vehicle and further configured to provide an indication that the vehicle ignition is in an on-state and further configured such that when the episodic sonic pulses stop, to send to a vehicle signal to the controller to activate the alarm and the alert;
a key position sensor configured to determine presence of a vehicle key and presence of a driver; and
a controller instruction set;
wherein said in-vehicle display device, said speaker and said controller are integrated into a single unit;
wherein said controller comprises a wireless radio frequency module, central processing unit located on an integrated circuit chip and further comprises logic, control and input/output operations configured by said controller instruction set.

2. The passenger seat occupancy alert system of claim 1, wherein the controller is configured to activate the in-vehicle display device on upon receipt of the sensor signal from the at least one sensor that the at least one passenger seat is occupied by the object.

3. The passenger seat occupancy alert system of claim 1, wherein the controller is configured to display the alert in real-time, responsive to and upon receipt of the sensor signal from the at least one sensor that the at least one passenger seat is occupied by the object and the vehicle signal from the detection means that the ignition system is in the off-state.

4. The passenger seat occupancy alert system of claim 1, wherein the controller is further configured to sound the alarm through the speaker in real-time, responsive to and upon the receipt of the sensor signal from the at least one sensor that the at least one passenger seat is occupied by the object and the vehicle signal from the detection means that the ignition system is in the off-state.

5. The passenger seat occupancy alert system of claim 1, wherein the in-vehicle display device includes a liquid crystal display (LCD) screen.

6. The passenger seat occupancy alert system of claim 1, wherein the in-vehicle display device includes a plurality of light-emitting diodes (LEDs).

7. The passenger seat occupancy alert system of claim 6, wherein the alert includes the plurality of light-emitting diodes flashing at a predetermined rate.

8. The passenger seat occupancy alert system of claim 1, wherein the speaker and the controller are integrated into the in-vehicle display device.

9. The passenger seat occupancy alert system of claim 1, wherein the key position sensor located proximate a key ignition switch in the vehicle, and configured to transmit the vehicle signal to the controller when the key ignition switch is in the off-state.

10. The passenger seat occupancy alert system of claim 1, wherein the ignition sensor communicably coupled to the ignition system of the vehicle, and configured to transmit the vehicle signal to the controller when the ignition system is in the off-state.

11. The passenger seat occupancy alert system of claim 1, wherein the at least one sensor includes a weight sensor.

12. The passenger seat occupancy alert system of claim 1, wherein the at least one sensor is integrated within the at least one passenger seat.

13. The passenger seat occupancy alert system of claim 1, wherein the in-vehicle display device is configured to install on a dashboard of the vehicle.

14. The passenger seat occupancy alert system of claim 1, wherein the at least one sensor is configured to detect the object having a weight of at least 2 lb.

15. The passenger seat occupancy alert system of claim 1, wherein the in-vehicle display device is configured to display the alert after a predetermined time interval upon receipt of the sensor signal from the at least one sensor that the at least one passenger seat is occupied by the object, and of the vehicle signal from the detection means that the ignition system is in the off-state.

16. The passenger seat occupancy alert system of claim 1, wherein the in-vehicle display device further includes a wireless transceiver; and
wherein the at least one sensor and the detection means are configured to wirelessly communicate with the in-vehicle display device.

17. A passenger seat occupancy alert system for a vehicle, the vehicle including at least one passenger seat and an ignition system, the passenger seat occupancy alert system comprising:
at least one sensor coupled to the at least one passenger seat, the at least one sensor configured to detect when the at least one passenger seat is occupied by an object, the at least one sensor further configured to transmit a sensor signal when the at least one passenger seat is occupied by the object;
a detection means configured to detect an off-state of the ignition system, the detection means further configured to transmit a vehicle signal when the ignition system is in the off-state;
an in-vehicle display device communicably coupled with the at least one sensor and with the detection means, the in-vehicle display device configured to display an alert;
a speaker configured to sound an alarm; and
a controller configured to sound the alarm and to display the alert on the in-vehicle display device;
an ignition sensor configured to receive episodic sonic pulses from the ignition system of the vehicle and further configured to provide an indication that the vehicle ignition is in an on-state and further configured such that when the episodic sonic pulses stop, to send to a vehicle signal to the controller to activate the alarm and the alert;
a key position sensor configured to determine presence of a vehicle key and presence of a driver; and
a controller instruction set;
wherein said in-vehicle display device, said speaker and said controller are integrated into a single unit;
wherein said controller comprises a wireless radio frequency module, central processing unit located on an integrated circuit chip and further comprises logic, control and input/output operations configured by said controller instruction set;
wherein the controller is configured to activate the in-vehicle display device on upon receipt of the sensor signal from the at least one sensor that the at least one passenger seat is occupied by the object;
wherein the controller is configured to display the alert in real-time, responsive to and upon receipt of the sensor signal from the at least one sensor that the at least one passenger seat is occupied by the object and the vehicle signal from the detection means that the ignition system is in the off-state;
wherein the controller is further configured to sound the alarm through the speaker in real-time, responsive to and upon the receipt of the sensor signal from the at least one sensor that the at least one passenger seat is occupied by the object and the vehicle signal from the detection means that the ignition system is in the off-state;
wherein the in-vehicle display device includes a liquid crystal display (LCD) screen;
wherein the in-vehicle display device includes a plurality of light-emitting diodes (LEDs);
wherein the alert includes the plurality of light-emitting diodes flashing at a predetermined rate;
wherein the speaker and the controller are integrated into the in-vehicle display device;
wherein the detection means includes a key position sensor located proximate a key ignition switch in the vehicle and configured to transmit the vehicle signal to the controller when the key ignition switch is in the off-state;
wherein the at least one sensor includes a weight sensor;
wherein the at least one sensor is integrated within the at least one passenger seat;
wherein the in-vehicle display device is configured to install on a dashboard of the vehicle;
wherein the at least one sensor is configured to detect the object having a weight of at least 2 lbs.;
wherein the in-vehicle display device is configured to display the alert after a predetermined time interval upon receipt of the sensor signal from the at least one sensor that the at least one passenger seat is occupied by the object, and of the vehicle signal from the detection means that the ignition system is in the off-state;
wherein the in-vehicle display device further includes a wireless transceiver; and
wherein the at least one sensor and the detection means are configured to wirelessly communicate with the in-vehicle display device.

18. The passenger seat occupancy alert system of claim 17, further comprising set of instructions; and
wherein the passenger seat occupancy alert system is arranged as a kit.

19. A method for installing the passenger seat occupancy alert system of claim 17 in a vehicle, the vehicle including at least one passenger seat, an ignition system, an ignition key switch and a dashboard, the method comprising the steps of:
coupling at least one sensor to the at least one passenger seat, the at least one sensor configured to detect when the at least one passenger seat is occupied by an object;
installing a detection means proximate the ignition key switch, the detection means configured to detect an off-state off the ignition key switch, and to transmit a signal when the ignition key switch is in the off-state;
installing an in-vehicle display device to the dashboard of the vehicle, the in-vehicle display device configured to display an alert;
positioning the in-vehicle display device on the dashboard such that the alert displayed by the in-vehicle display device is viewable by a driver of the vehicle; and
communicably coupling the in-vehicle display device with the at least one sensor and the detection means.

20. The method of claim 19, further comprising the step of wirelessly communicably coupling the in-vehicle display device with the at least one sensor and the detection means.
